(19) United States
(12) Patent Application Publication
(10) Pub. No.: US 2013/0192108 A1
(43) Pub. Date: Aug. 1, 2013

(54) SYSTEM AND APPARATUS FOR A REMOVABLE COVER FOR WINDOW VIEWPORT AND A METHOD OF USE THEREFOR

(71) Applicant: Suresh MADHAVAN, Wall, NJ (US)

(72) Inventor: Suresh MADHAVAN, Wall, NJ (US)

(21) Appl. No.: 13/561,215

(22) Filed: Jul. 30, 2012

Related U.S. Application Data
(60) Provisional application No. 61/513,692, filed on Aug. 1, 2011.
(60) Provisional application No. 61/593,445, filed on Feb. 1, 2012.

(51) Int. Cl. G09F 23/00; B32B 37/18; B32B 3/26; B32B 3/10; B32B 7/06

(52) U.S. Cl. CPC G09F 23/00; B32B 3/10; B32B 7/06; B32B 3/266; B32B 37/18
USPC 40/594; 428/195.1; 428/42.1; 428/43; 428/137; 156/60; 156/327

(57) ABSTRACT

The invention relates to a removable and decorative or informative circumferential cover to at least partially surround a viewing area of a display device, and in particular to a removable cover therefore. The display device or windowed viewport may be, for instance, an active viewing area such as a TV screen, a computer screen, a monitor screen, a handheld device screen, and so forth. The display device may also be a passive viewing area such as a painting, a poster, a beverage refrigerator, a display case, etc. The display device may also be, for instance, a conventional window or any other area that may surround or frame an area.

### CROSS-REFERENCE TO RELATED APPLICATIONS

This application relates to and claims priority from U.S. Provisional Application Ser. No. 61/513,692 filed Aug. 1, 2011 and U.S. Provisional Application Ser. No. 61/593,445, filed Feb. 1, 2012, the entire contents of which are incorporated herein fully by reference.

### BACKGROUND OF THE INVENTION

1. Field of the Invention

The present invention relates to a removable and decorative circumferential cover to at least partially surround an area. More particularly, the present invention provides a removable cover for a windowed viewport, such as a TV screen, a computer screen, a monitor screen, a handheld device screen, and the like.

2. Description of the Related Art

Subliminal advertising has been around since the 1950's. And for decades now, it has been proven to be the most effective way to influence consumer behavior by subconsciously altering preferences and attitudes toward consumer products.

Research has proven that most people walk past posters, signs and banners without cognitively absorbing their message. And while watching TV, people can walk away or shift their attention during commercials. In fact, with the advent of Digital Video Recorders (DVRs) and websites which allow viewers to watch their favorite shows without commercial interruption (e.g., Hulu), commercials have lost the impact they used to have on consumers. This is because the aforementioned technology now allows people to watch their favorite shows and events without having to sit through all the commercials.

In this techno-centric society in which we now live, people are spending more and more time looking at television monitors, cell phones and now tablets. There exists a need for an improved advertising tool that is present within one's peripheral vision the entire time the person is looking at the television monitor, cell phone or tablet. There also exists the need for an improved advertising tool that has the potential to shift people's vision into a temporary state of central scotoma, thus enabling one's company message, product and/or promotion to be ingrained into the subconscious mind of their target clientele more powerfully than ever before, which can have the effect of altering consumer attitudes and preferences.

In addition, where everything seems to be personalized and almost everyone owns a television, display monitor of some sort, cell phone, tablet, etc., there is a need for a display that is more appealing, interesting in appearance and has the potential to be changed easily, and which could offer certain advertising benefits. The apparatus of the present invention addresses this need, and enables users to customize their displays to fit their personal tastes, decor, or just the way they feel, and allows them to display certain types of advertisements, if desired.

In the past, devices have been proposed to alter the appearance or offer a useful element to a display. Such devices are usually fixed or otherwise secured to the display in some fashion. Unlike the prior art, however, the screen border or frame of the present invention, once removably affixed to the display, may be temporarily displaced to provide the user with access to control buttons positioned on the display and may be easily replaced without leaving residue on or causing damage to the display.

For instance, one such display apparatus is affixed to the sides and top of a computer monitor. Channel members are provided along the sides and top to hold large “L” shaped display members. Images are then attached to the display members. Another such device is a note/memo board designed to surround a computer display housing on only three sides. The board attaches to the display housing with the use of angle brackets backed with VELCRO® material with matching strips on the sides and top of the device. The note/memo board, however, mounts to the back of the computer screen, not on the actual face, which positions the screen beyond the user's field of focus.

Still another device is a die-cut display board for a computer video monitor wherein a cardboard, plastic, or foam back is secured to the computer video monitor by means of double-stick tape or a VELCRO® material. The middle region, where the screen would appear, is scored such that the middle may be pushed apart creating tabs to be folded in towards the rear of the device to lie on the top and the sides of the monitor to form an opening to view the screen. Another device is a frame assembly that adheres to the face of a computer monitor by means of a repositionable pressure sensitive adhesive. The front surface of the frame is adapted to have sheets of paper and other objects releasably adhered thereto. The frame assembly may also include different sized central cut outs to fit devices having different sized view able surfaces.

Another such device is an apparatus for positioning around a screen comprising, a strap of a flexible material with a circumference that allows it to be positioned around the upper surface, lower surface and side surfaces of the screen that assumes a rectangular configuration when placed therearound. A decorative attachment, in the form of a doll, sports event scene, beach scene or the like, may then be supported by the strap.

### SUMMARY OF THE INVENTION

The present invention is a revolutionary marketing tool which will allow one to enhance their company's name, message and sales more powerfully than ever before. The present invention provides the ability to promote products and offers to their target audiences on the most highly viewed area within any establishment, namely, television monitors.

The present invention generally relates to a removable and decorative circumferential cover (also referred herein as a circumferential cover) to at least partially surround an area, and in particular to a removable cover for a windowed viewport. The window viewport may be, for instance, an active viewing area such as a TV screen, a computer screen, a monitor screen, a handheld device screen, and the like. The window viewport may also be a passive viewing area such as a painting, a poster, a beverage refrigerator, a display case, etc. The window viewport may also be, for instance, a conventional window or any other area that may surround or frame an area.

The circumferential cover may be substantially planar, having a first major surface and a second major surface, the second major surface being disposed in a direction substantially perpendicular to the first major surface. The circumferential cover may have a desired visual design printed directly on the first major surface, or affixed directly to the first major surface. The visual design may be any form of indicia, for instance, a color or set of colors, geometric shapes, free-form shapes, an artwork, text, etc.

The circumferential cover may further include an attachment apparatus to attach the circumferential cover to a surface. The surface may be, for example, a bevel area surrounding the windowed viewport, or the windowed viewport itself. In one embodiment in accordance with the present invention, the attachment apparatus may be disposed in a direction opposite from the desired visual design, for instance on tabs that extend planarly outward from the circumferential cover. In another embodiment in accordance with the present invention, the attachment apparatus may be disposed on the second major surface. The attachment apparatus may include, but is not limited to, an adhesive or an area susceptible to static cling or static electricity.

The device of present invention comprises a unique vinyl material that adheres to the frame of flat screen display, e.g., a flat screen television or computer monitor. The cover may be easily applied to any display that has a smooth, flat frame around its screen. It may also be applied to semi-smooth surfaces that border displays such as perforated frames which have integrated speakers. One of the primary features of the present invention is that it has strong adhesion without leaving any residue upon removal. This also allows the present invention to come in contact with the viewing screen without causing any damage.

An important step in the process for producing and providing the device or cover of the present invention is the measuring of the area to be covered. Because the present invention is custom cut to each television by a laser guided machine, exact measurements are important to the production process. With exact measurements, it will look as if the cover or device of the present invention is actually a part of the display or viewport.

Preferably, the cover of the present invention is to be applied to display or viewport frame that has been thoroughly cleaned and that are free of dust, grease, debris and prior adhesive residues. Once applied, the cover may be wiped down with any non-alcohol based solution, such as Windex.

The present invention is preferably printed using “Earth Friendly” eco-solvent ink and is engineered such that it will not fade even with prolonged exposure to sunlight. Preferably, the cover of the present invention will not affect the use of remote controls to operate the display or viewport as wireless signals will pass through seamlessly.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 illustrates a windowed viewport with a bezel area;

FIG. 2A illustrates a circumferential cover attached to a bezel in accordance with an embodiment of the present invention;

FIG. 2B illustrates a circumferential cover attached to the windowed viewport just inside of a bezel in accordance with an embodiment of the present invention;

FIG. 3 illustrates a circumferential cover attached to the windowed viewport in accordance with an embodiment of the present invention;

FIG. 4 illustrates a conventional flat screen display device for which the cover of the present invention may be used;

FIG. 5 illustrates the circumferential cover of the invention being attached to the bezel of a flat panel display device in accordance with a preferred embodiment of the present invention; and

FIG. 6 illustrates a circumferential cover of the invention being attached to the flat screen display area just inside of the bezel of the flat screen display device in accordance with an alternate embodiment of the present invention.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

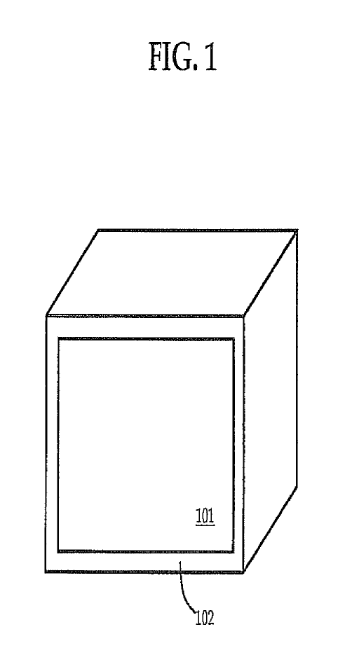

Referring first to FIG. 1, shown is a windowed viewport with a bezel area constructed in accordance with this invention. As will be described in more detail below, FIG. 1 illustrates a windowed viewport 101 having a bezel 102 forming a circumferential area around the windowed viewport 101. The windowed viewport 101 may comprise, for instance, a computer screen, TV, window, beverage refrigerator, display case, and the like.

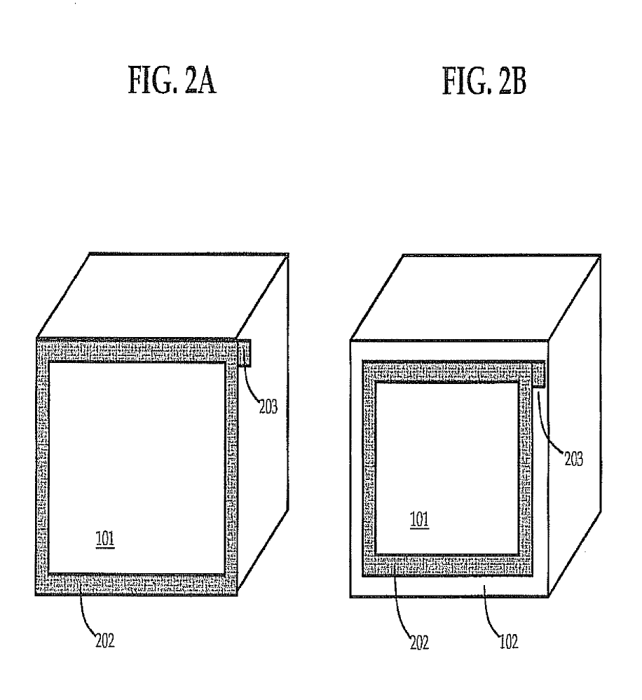

Turning next to FIG. 2A, illustrated is a windowed viewport 101 having a circumferential cover 202 applied over bevel 102 (not shown in FIG. 2A). The circumferential cover 202 may include a small tab 203 or the like in order to aid in the removal of the circumferential cover 202. The circumferential cover 202 may be formed with a desired pattern as described above. In the preferred embodiment of the invention, a removable and decorative circumferential cover 202 is provided for attachment to at least partially surround a windowed viewport 101. The windowed viewport 101 may be, for instance, an active viewing area such as a TV screen, a computer screen, a monitor screen, a handheld device screen, and so forth. The windowed viewport 101 may also be a passive viewing area such as a painting, a poster, a beverage refrigerator, a display case, etc. The windowed viewport may also be, for instance, a conventional window or any other area that may surround or frame an area.

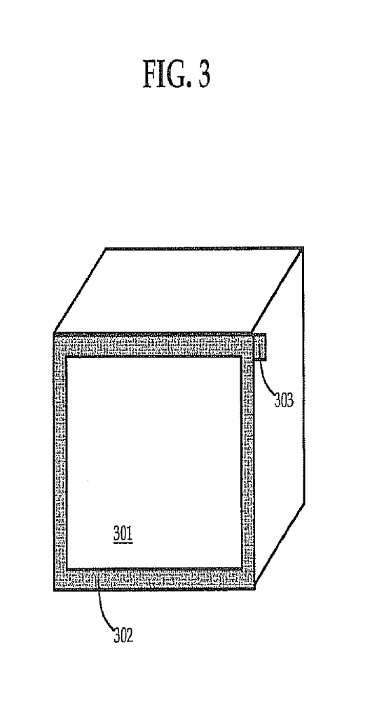

As shown in FIG. 2B, removable and decorative circumferential cover 202 may alternatively be applied on the screen of the windowed viewport 101 just inside the bezel 102. Optionally, the circumferential cover 202 may include a small tab 203 or the like in order to aid in the removal of the circumferential cover 202. The circumferential cover 202 may be formed with a desired pattern as described above. Alternatively, circumferential cover 202 may be utilized with a windowed viewport 301 that does not have a bezel, as seen in FIG. 3. The windowed viewport 301 may comprise a display case and the like. A circumferential cover 302 is applied on the windowed viewport 301. The circumferential cover 302 may include a small tab 303 or the like in order to aid in the removal of the circumferential cover 302. The circumferential cover 302 may be formed with a desired pattern as described above.

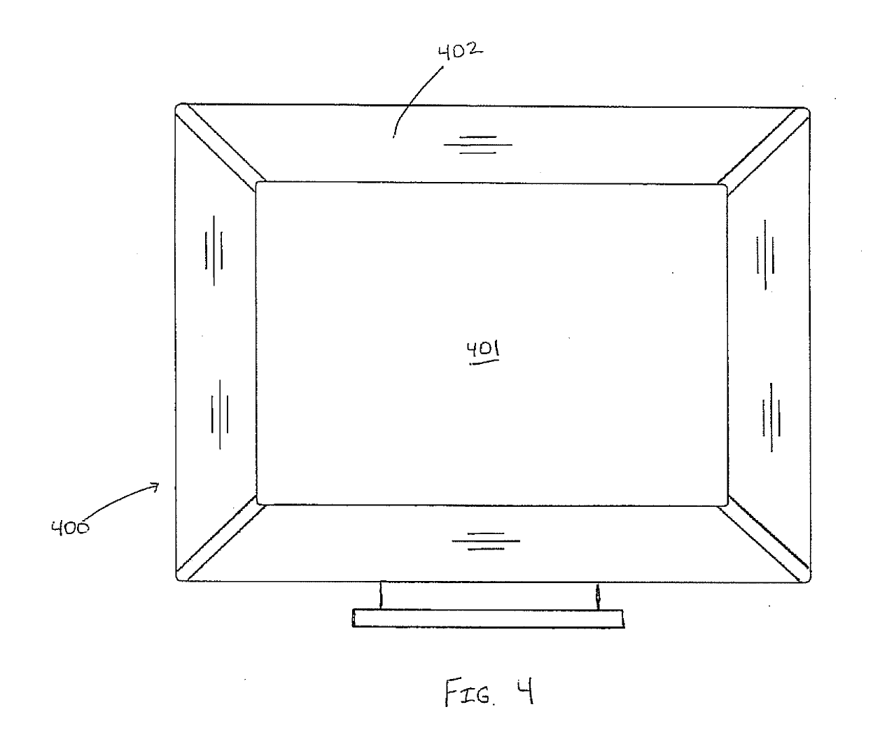

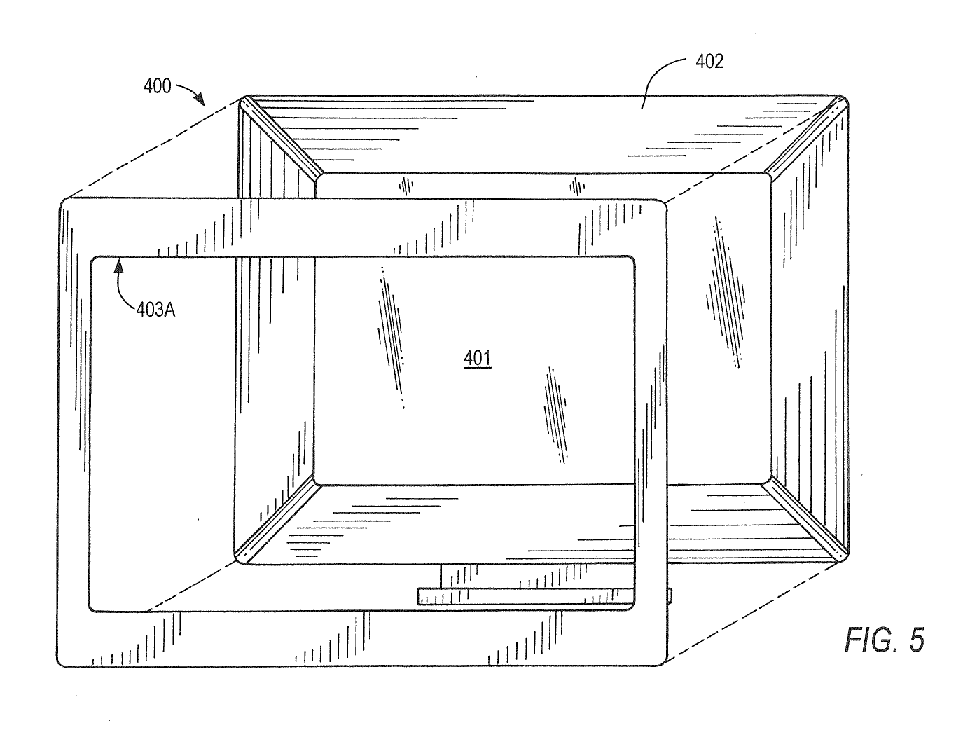

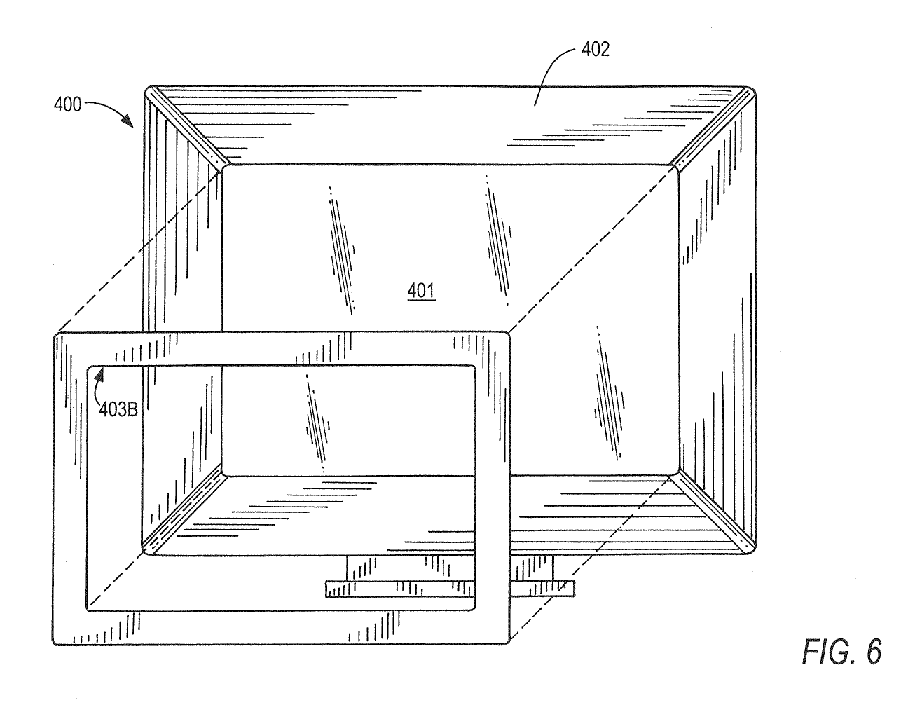

Turning next to FIGS. 4-6, illustrated is a conventional flat screen display device 400 comprising a viewing screen 401 and a surrounding bezel 402 for which the circumferential cover 403A-B according to the present invention may be used. As illustrated in FIG. 5, in the preferred embodiment of the invention, the circumferential cover 403A may be attached to the bezel 402 of a flat panel display device 400, or as seen in FIG. 6, circumferential cover 403B may alternatively be sized to be attached to the viewing screen area 401 just inside of the bezel 402 of the flat screen display device 400. The circumferential cover 403A/B is preferably substantially planar and generally rectangular in accordance with the particular size of the flat panel display device 400. Optionally, cover 403A/B may have a first major surface and a second major surface, the second major surface being disposed in a direction substantially perpendicular to the first major surface. The circumferential cover 403A/B preferably has a desired visual appearance or design formed directly on the first major surface (as seen, for example, in FIGS. 5-6), or alternatively affixed directly to the first major surface. The visual design may be, for instance, an advertisement, logo, color or set of colors, pattern, geometric shape, free-form shape, artwork, text, company brand, slogans, images, names, designs, graphics, photographs, or any combination thereof.

As shown in FIGS. 5 and 6, the circumferential adhesive cover 403A/B is cut, shaped and sized to substantially match the bezel 402 of a display device 400 or the substantially match the viewing screen 401 of the display device 400 to which it may be adhered. Furthermore, the circumferential adhesive cover 403A/B does not interfere with the functionality of the display device 400. For example, the cover 403A/B includes a central opening which, in one embodiment (see e.g., FIG. 5), substantially matches the size and shape of the viewing screen 401 of the display device 400, or in a second embodiment (see e.g., FIG. 6), is sized to maximize the viewing area of viewing screen while also providing the desired design or advertising effect to the user.

As discussed above, the circumferential adhesive cover 403A/B preferably comprises a single unitary piece to be applied to the display device 400. Alternatively, the circumferential adhesive cover 403A/B may comprise more than one piece to be applied separately such that each piece or section may comprise a different design or different advertisement. While cover 403A/B is preferably composed of material that will not interfere with the operation of the display device 400, in other embodiments, tear away sections, peel away sections, or punch out sections may also be provided to permit parts of the display device 400 to function if necessary. These parts of the display device 400 may include, but are not limited to, controls, dials, buttons, input/output jacks, speakers, hardware connector ports, battery compartments and the like. Furthermore, embodiments of circumferential adhesive cover 403A in accordance with the present invention may comprise precise dimensions such that the circumferential adhesive cover 403A is capable of covering all of the bezel 402 of the display device 400. In other embodiments, a circumferential adhesive cover 403B may comprise precise dimensions such that the circumferential adhesive cover 403B is capable of covering only a very limited area of viewing screen 401 such that it may be applied adjacent to the inner edge of bezel 402 of the display device 400.

In accordance with various embodiments of the present invention, circumferential adhesive cover 403A/B may be customized or personalized to include one or more individual designs. In accordance with the invention, such designs may be provided by a customer or person who wishes to customize their own display device 400 or may be provided by a manufacturer of the circumferential adhesive cover 403A/B or may be provided by a particular company or advertising agency, or by any other entity. Any known method of producing the design to the circumferential adhesive cover 403A/B may be employed, e.g. printing, screen printing, silk screening, flocking, chemically burning, etc.

The circumferential adhesive cover 403A/B may comprise a relatively lightweight and flexible material. Preferably, the circumferential adhesive cover 403A/B is comprised of polyvinyl chloride film (approximately 64-69% by weight), acrylic copolymer pressure sensitive adhesive (approximately 3-5% by weight), silicone coated paper release liner (approximately 27-31% by weight). In embodiments in accordance with the present invention, the material may comprise paper, cloth, plastic, vinyl, combinations thereof, and so forth. The circumferential adhesive cover 403A/B may comprise a surface upon which the desired visual appearance or design may be formed by a PC-controlled printer and applied directly on the cover surface without the need for any primers or additional layers. The circumferential adhesive cover 403A/B may be formed as one integral piece, or may be formed in sections, for instance a section corresponding to a side of the area at least partially enclosed by the circumferential adhesive cover 403A/B.

The circumferential adhesive cover 403A/B may further include an attachment apparatus to removably attach the circumferential adhesive cover 403A/B to a surface. The surface may be, for example, a bezel area surrounding the windowed viewport, or the windowed viewport itself. In one embodiment in accordance with the present invention, the attachment apparatus may be disposed in a direction opposite from the desired visual design, for instance on tabs that extend planarly outward from the circumferential adhesive cover 403A/B (see e.g., FIGS. 2A-B). In another embodiment in accordance with the present invention, the attachment apparatus may be disposed on the second major surface. The attachment apparatus may include, but is not limited to, an adhesive or an area susceptible to static cling or static electricity.

The attachment apparatus provides enough attachment force to keep the circumferential adhesive cover 403A/B immobile, but the attachment force is low enough that the circumferential adhesive cover 403A/B may be removable by a person without undue use of force, risk of damage to the bevel area 402 or the viewing screen 401 of the display device 400 (or windowed viewport), tearing of the circumferential cover or the leaving behind of relatively excessive residue. A circumferential adhesive cover 403A/B so removed may be reapplied to the bezel area 402 or the viewing screen 401 without additional adhesive, for instance if a user attempts to adjust a position of the circumferential adhesive cover 403A/B on the bezel area 402 or the viewing screen 401. The circumferential adhesive cover 403A/B may be attached to the bezel area 402 or the viewing screen 401 of the display device 400 without use of additional support members.

The circumferential adhesive cover 403A/B, comprising a flexible material without additional support members, ordinarily will not significantly extend beyond the top, left or right outer edges of the bezel area 402, or the viewing screen 401 if there is no bezel, so as not to provide a wrinkled appearance. Furthermore, if the circumferential adhesive cover 403A/B is applied directly to the viewing screen 401 just inside the bezel 402, the circumferential adhesive cover 403A/B may or may not significantly extend beyond the viewing screen 401 onto the bezel 402. A small extension of at least a portion of the circumferential adhesive cover 403A/B (e.g., a tab at a corner) may be useful in order to aid in the removal of the circumferential adhesive cover 403A/B. The circumferential adhesive cover 403A/B may further comprise an overlaid portion that may extend beyond the inner edge of the bezel area 402, for instance from the left side of the viewing screen 401 to the right side of the viewing screen 401. The overlaid portion may be substantially transparent, and may provide additional visual benefits such as an anti-glare property, polarization, or a color filtering property. The circumferential adhesive cover 403A/B may extend to a greater extent along a bottom portion of the bezel area 402 or the viewing screen 401 itself, thereby using gravity to help avoid a wrinkled appearance. Optionally, portions of the circumferential adhesive cover 403A/B may be detachable in order to uncover a portion of the bezel area 402, for instance a portion of the bezel area 402 that may include controls of the display device 400, an LED indicator, an electrical connector, a receiver for a remote control, speakers, etc.

No element, act, or instruction used in the description of the present application should be construed as critical or essential to the invention unless explicitly described as such. Also, as used herein, the article a is intended to include one or more items. Where only one item is intended, the term one or similar language is used. Further, the terms any of followed by a listing of a plurality of items and/or a plurality of categories of items, as used herein, are intended to include any of, any combination of, any multiple of, and/or any combination of multiples of the items and/or the categories of items, individually or in conjunction with other items and/or other categories of items.

Moreover, the claims should not be read as limited to the described order or elements unless stated to that effect. In addition, use of the term means in any claim is intended to invoke 35 U.S.C. §112, ¶6, and any claim without the word means is not so intended. In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. It is understood that various embodiments described herein may be utilized in combination with any other embodiment described, without departing from the scope contained herein. Further, the foregoing description is not intended to be exhaustive or to limit the present invention to the precise form disclosed. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. An adhesive cover for a display device, comprising:
a base layer comprising polyvinyl chloride film;
an adhesive layer comprising an acrylic copolymer pressure sensitive adhesive, wherein the adhesive layer is applied to a bottom surface of the base layer; and
a print layer applied to a top surface of the base layer, wherein the print layer comprises a design.

2. The adhesive cover according to claim 1, wherein the cover is comprised of approximately 64-69% by weight polyvinyl chloride film.

3. The adhesive cover according to claim 1, wherein the cover is comprised of approximately 3-5% by weight acrylic copolymer pressure sensitive adhesive.

4. The adhesive cover according to claim 1, wherein the cover is manufactured using a substrate layer comprised of approximately 27-31% by weight silicone coated paper release liner.

5. The adhesive cover according to claim 1, further comprising a primer layer applied to the top surface of the base layer to facilitate application of the print layer to the base layer.

6. The adhesive cover according to claim 1, wherein the print layer is applied to the base layer by a process selected from the group consisting of printing, screen printing, silk screening, flocking, chemical burning, and etching.

7. The adhesive cover according to claim 1, wherein the cover has a shape that facilitates adhering the cover to the surface of a windowed display device.

8. The adhesive cover according to claim 1, further comprising one or more apertures, tear away sections, punch out sections, peel away sections, or a combination thereof.

9. The adhesive cover of claim 1, wherein the design comprises one or more advertisement, logo, color or set of colors, pattern, geometric shape, free-form shape, artwork, text, company brand, slogans, images, names, designs, graphics, photographs, or any combination thereof.

10. An advertising method, comprising the steps of:
a) providing a display device, said display device being mounted on a wall and having bezel and a viewing screen bounded by said top, left side, right side and bottom;
b) providing a circumferential cover having a design, said cover being adapted for releasable attachment to said display device and being adapted to cover at least said bezel; and
c) attaching said cover to said display device to cover at least said bezel.

11. The method according to claim 10, wherein said design comprises one or more advertisement, logo, color or set of colors, pattern, geometric shape, free-form shape, artwork, text, company brand, slogans, images, names, designs, graphics, photographs, or any combination thereof.

12. The method according to claim 10, wherein the cover is comprised of approximately 64-69% by weight polyvinyl chloride film.

13. The method according to claim 10, wherein the cover is comprised of approximately 3-5% by weight acrylic copolymer pressure sensitive adhesive.

14. The method according to claim 10, wherein the cover is manufactured using a substrate layer comprised of approximately 27-31% by weight silicone coated paper release liner.
